(19) United States
(12) Patent Application Publication
(10) Pub. No.: US 2026/0127649 A1
(43) Pub. Date: May 7, 2026

(54) AUTOMATING QUALITY CONTROL OF QUOTES USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Colin Guilfoyle, Dorgheda (IE)

(73) Assignee: Trilogy Enterprises, Inc., Austin, TX (US)

(21) Appl. No.: 19/378,091

(22) Filed: Nov. 3, 2025

Related U.S. Application Data
(60) Provisional application No. 63/714,899, filed on Nov. 1, 2024.

(51) Int. Cl. G06Q 30/0601; G06Q 30/01

(52) U.S. Cl. CPC G06Q 30/0611; G06Q 30/01

(57) ABSTRACT

The system and method for guiding an Artificial Intelligence (AI) engine to automate the quality control process for generating quotes. The quote generation process involves receiving quote requests from a customer relationship management (CRM) system or a data structure entry point. Moreover, retrieving quote data associated with the quote request from data sources, including a CRM platform, via application programming interfaces (APIs) triggered by the submission of the quote request. Furthermore, the prompts are generated by a prompt generator to guide the AI engine in validating the retrieved quote data. The prompts are then transferred to the AI engine for validation, a process that involves analyzing the quote data against predefined rules and conditions, such as price structures, terms, and conditions. Subsequently, a quality control result is generated based on the validation, indicating whether the quote passes or fails the validation process.

### CROSS-REFERENCE TO RELATED APPLICATION(S)

This application claims the benefit under 35 U.S.C. § 119(e) and 37 C.F.R. § 1.78 of U.S. Provisional Application No. 63/714,899, which is incorporated by reference in its entirety.

### FIELD OF THE INVENTION

The present invention relates in general to the field of electronics, and more specifically to systems and methods for automating quality control of quotes using integrated programmatic and specialized guided and constrained artificial intelligence.

### BACKGROUND

The traditional method of quote generation and quality control (QC) has long relied on manual processes. This manual approach is not only inefficient but also introduced a host of problems that impacted both the workflow and the overall outcomes. One of the major issues with the manual processes is that it is time-consuming. In a business environment where time is of the essence, the manual process of generating quotes and conducting quality checks could result in significant delays. These delays occurred because the process required a finance team, or sometimes a dedicated QC team, to meticulously review each and every quote to ensure the accuracy. This level of scrutiny, while necessary, meant that businesses often had to wait several days before a quote could be approved, finalized, and sent to the customer.

The sheer length of time taken for this review process had a ripple effect on other areas of the business. For instance, when a quote is delayed, it could hold up other operations, such as project initiation, product delivery, or service provision, all of which were dependent on accurate and timely quotes. These delays could result in a loss of business or customer dissatisfaction. Furthermore, extended delays often impacted cash flow, especially in cases where inaccurate quotes led to billing errors or delayed invoices, preventing the timely collection of revenue.

The traditional quote generation process is prone to human error. Human oversight is inevitable, especially when dealing with complex pricing models, a multitude of terms and conditions, or when quotes involve intricate calculations. The risk of error was particularly high when the workload was heavy, and staff were pressed to meet deadlines. Under such conditions, small mistakes in pricing, discounts, or terms could occur, resulting in significant financial implications for the business. For example, a miscalculation in the quote could mean underpricing a product or service, which would lead to reduced profit margins. Conversely, overpricing due to an error could make the company less competitive in the market, leading to lost business opportunities.

In the traditional quote generation process the review of terms and conditions are usually done manually. The terms and conditions outlined the agreed-upon price, deliverables, timelines, and any other contractual obligations. Ensuring that the correct terms and conditions were applied to each quote was an essential part of the process. However, because this aspect of QC is handled manually, it is subject to frequent errors. Incorrect terms and conditions could easily slip through the cracks, especially if the team reviewing the quotes is unfamiliar with the specifics of certain agreements or if they were dealing with an overwhelming volume of work. The misapplication of terms and conditions could lead to a host of problems. In some cases, customers could receive favorable terms that were not intended for them, resulting in lower revenue for the business. In other situations, customers might be overcharged or subjected to unfavorable terms, leading to disputes and a potential loss of trust.

The manual QC process required a considerable amount of human resources. Finance teams, or teams specifically designated for quality control, had to dedicate a significant portion of their time to reviewing quotes, which prevented them from focusing on other critical tasks that could add more value to the organization. These tasks might include strategic financial planning, identifying cost-saving opportunities, or working on process improvements. Instead, highly skilled individuals were often bogged down by the repetitive and time-intensive task of reviewing quotes for errors.

The high failure rate in QC for quote generation is another critical issue in the traditional method of quote generation and QC. When the QC failed to catch the issues in time, it could result in serious consequences, including revenue leakage, customer dissatisfaction, and potential legal liabilities. The manual review process was further complicated by the need to collaborate with other departments or stakeholders. For example, the finance team might need to cross-check certain elements of a quote with the legal department to ensure compliance with contractual obligations, or with the sales team to confirm that the pricing was in line with the customer's negotiated terms. This back-and-forth communication often caused additional delays and created more opportunities for errors.

Furthermore, the reliance on manual processes made it difficult to maintain a consistent level of quality across all quotes. Different team members might interpret terms and conditions differently, leading to inconsistencies in how quotes were generated and reviewed. This lack of standardization created a situation where some quotes were more prone to errors than others, depending on who was handling the review process. Customers who received inconsistent quotes might lose confidence in the company's ability to manage its pricing and contractual obligations, which could damage the business's reputation and lead to lost opportunities.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary quote generation system for automating quality control of quotes.

FIG. 2 depicts an exemplary quote generation process utilized by the quote generation system.

FIG. 3 is a feedback generation process, which is an embodiment of the quote generation process of FIG. 2.

FIG. 4 depicts a data structure for generating validated quotes.

FIG. 5 depicts an exemplary network environment in which the system of FIG. 1 and the process of FIG. 2 may be practiced.

FIG. 6 depicts an exemplary computer system.

### DETAILED DESCRIPTION

The system and method for guiding an Artificial Intelligence (AI) engine to automate the quality control process for generating quotes. The quote generation process involves receiving quote requests from a customer relationship management (CRM) system or a data structure entry point. Moreover, retrieving quote data associated with the quote request from data sources, including a CRM platform, via application programming interfaces (APIs) triggered by the submission of the quote request. Furthermore, the prompts are generated by a prompt generator to guide the AI engine in validating the retrieved quote data. The prompts are then transferred to the AI engine for validation, a process that involves analyzing the quote data against predefined rules and conditions, such as price structures, terms, and conditions. Subsequently, a quality control result is generated based on the validation, indicating whether the quote passes or fails the validation process.

Additionally, providing real-time feedback to the user, offering detailed information on any discrepancies or required corrections if the quality control result indicates a failure. The AI engine utilizes machine learning algorithms to dynamically adjust the validation criteria based on historical data and patterns identified in previous quote requests. The data structure entry point is configured to handle alternative deal structures, providing necessary quote data for validation through predefined data formats. Furthermore, the feedback provided to the user, which includes detailed instructions for correcting identified discrepancies. This feedback is delivered through automated messaging systems or email in real time. Upon successful validation and passing of the quality control checks, the messaging systems or email automatically forwards the quote for further processing, including submission for electronic signature through a document-signing platform.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

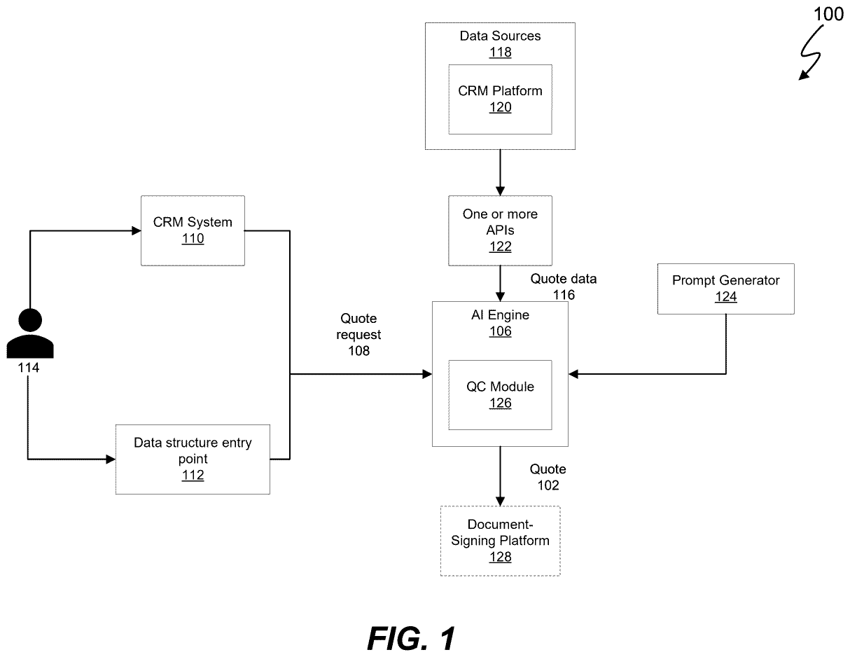

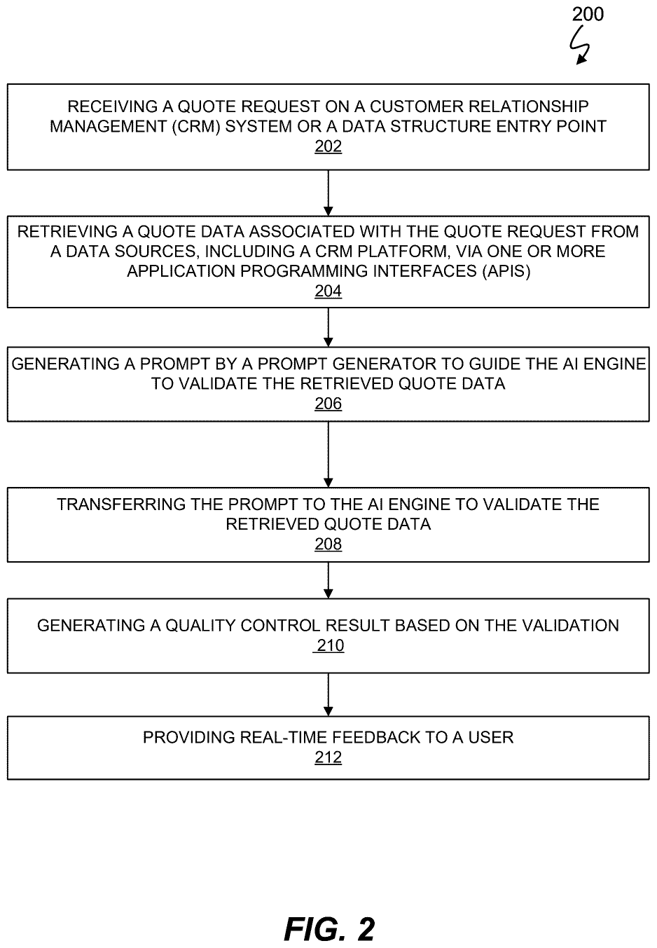

FIG. 1 depicts an exemplary quote generation system 100 for automating quality control of quotes 102. FIG. 2 depicts an exemplary quote generation process 200 utilized by the quote generation system 100.

The Artificial Intelligence (AI) engine 106 is designed for automating quality control of quotes 102 in quote generation. The AI engine 106 performs validation of a quote data 108, by analyzing the quote data 108 against a set of predefined rules and conditions. The validation criteria can be based on a variety of factors to generate a quality control (QC) result. This QC result is the outcome of the analysis of the AI engine 106 to indicate that the quote 102 has passed or failed the validation process. If the quote passes, it is forwarded for approval or signature. However, if the quote fails the validation, the AI engine 106 generates real-time feedback.

Referring to FIG. 1 and FIG. 2, in operation 202, receiving a quote request 108 from a customer relationship management (CRM) system 110 or a data structure entry point 112. The quote request 108 is a formal proposition initiated by a user 114 or by the customer or business representative to generate a detailed price estimate for a particular product or service. The quote request 108 typically outlines the scope of the service or product, the quantity, pricing terms, and any terms and conditions required by the business. The quote 102 must reflect up-to-date pricing, customer-specific discounts, and compliance. The CRM system 110 is used to maintain and manage the interactions of the user 114. The CRM system 110 may include Salesforce (SFDC) having headquarters in San Francisco, California, Microsoft Dynamics owned by Microsoft Dynamics, having headquarters in Redmond, Washington, United States, HubSpot having headquarters in Cambridge, Massachusetts, United States, and so forth, to store customer information and transactional data, including purchase history, contact details, communication logs, and quote request(s) 108.

Typically, the CRM systems 110 help to organize customer data, automate sales activities, and communicate between the user 114 and customers. The quote request 108 originates within the CRM system 110 when the customer requests pricing information for a product or service. The CRM system 110 is coupled with the AI engine 106. For example, a company using CRM system 110 such as Salesforce can set up an automated workflow where, when the user 114 initiates the quote request 108, the CRM system 110 operatively coupled with the AI engine 106, the CRM system 110 automatically triggers the AI engine 106 to begin processing. The AI engine 106 fetches all necessary details from, such as the product details, pricing tiers, customer information, and historical data, allowing it to produce an accurate, tailored quote 102 almost instantaneously.

The quote request 108 includes at least one of renewal, professional services, or new business quote. The renewal quotes are subscription models or long-term contracts, such as software-as-a-service (SaaS) businesses, telecommunications, and maintenance services. The renewal quote refers to the pricing and terms offered to a customer to extend or renew their existing contract. The professional services quotes are typically requested by businesses that require a custom service offering, such as consulting, implementation, or specialized support. Typically, the professional services quotes are complex and require careful consideration. The professional services quotes are customized based on the unique needs and the scope of the project. For example, the company may request quote 102 for a software implementation service, where the service provider must factor in the complexity of the integration, the number of team members required, travel costs, and the timeline for completion. The new business quotes are provided to prospective customers who are engaging with the company for the first time. The new business quotes tend to be more competitive, as the new business quotes often represent the company's first opportunity to secure a customer's business.

The quote request 108 can also be received from the data structure entry point 112. The data structure entry point 112 refers to an organized system or interface that handles structured data inputs related to quote requests 108. The data structure entry points 112 are particularly useful when handling customizable quotes 102, where handling new business quotes. In at least one embodiment, the data structure entry points 112 to receive quote requests that are complex in nature. For instance, the company might build custom quotes, where the customer can choose from different pricing models, service levels, and support options. The data structure entry point 112 can be Google sheet owned by Google, having headquarters in Mountain View, California, United States.

In operation 204, retrieving a quote data 116 associated with the quote request 108 from a data source 118, including a CRM platform 120 via one or more application programming interfaces (APIs) 122. The retrieval is triggered once the submission of the quote request 108 is done. The quote data 116 retrieval refers to gathering all relevant information that is needed to create the quote 102. The quote requests 108 come from the user 114 through various platforms, particularly from the CRM system 110 or from the data structure system 114. Once the quote request 108 is submitted, the retrieval process is initiated to pull in quote data 116 associated with the customer and the specific deal. The quote data 116 includes customer details, historical pricing agreements, product information, discount structures, and terms and conditions. The retrieval process is triggered the moment the quote request 108 is submitted. The quote data 116 is gathered in real time, improving the speed and efficiency of the overall quote generation system 100. The one or more APIs 122 configured to retrieve the necessary data from the data sources 118 such as the CRM platform 120 to ensure the quote 102 is populated with accurate, relevant, and up-to-date information.

The CRM platform 120 is used to manage customer information, track sales interactions, and handle various transactional activities. When the user 114 initiates the quote request 108, the user 114 typically inputs data regarding the specific products or services being quoted, the customer's details, and any other relevant information. The data source 118 holds customer information, including purchase history, communication logs, and account-specific pricing agreements. The data source 118 serves as a central repository of data for the generation of the quotes 102. When the quote request 108 is submitted. The one or more APIs 122 establishes the connection to pull in quote data 116 such as customer information, product details, historical data, and custom pricing agreements. The customer information includes customer name, contact details, billing addresses, and account status. The product details retrieve information about the products or services being quoted, including standard pricing, available configurations, and product codes. The historical data involves quotes 102 for existing users 114 to pull in information on previous transactions, contracts, and any applicable loyalty or volume discounts. The custom pricing agreements include negotiated pricing agreements with user 114.

The one or more APIs 122 act as the bridge that connects the CRM platform 120 to AI engine 106, enabling the seamless retrieval of quote data 116 from the data sources 118. The one or more APIs 122 is a set of rules and protocols that allow communication. The one or more APIs 122 facilitate the flow of information from the data sources 118. The one or more APIs 122 allow for the real-time retrieval of quote data 116, ensuring that the information used to generate quotes 102 is always current and accurate. For example, when the quote request 108 is submitted, the one or more APIs 122 triggers to immediately retrieve the necessary quote data 116 from the data source 118. In at least one embodiment, the one or more APIs 122 can be configured to pull data from multiple data sources 118 simultaneously.

When the quote request 108 is submitted, the CRM system 110 recognizes the event to trigger the retrieval process. This trigger activates the one or more APIs 122, which then connects to the relevant data source 118 and pulls in the information needed to help the AI system to validate the quote 102. Furthermore, automating the retrieval process ensures that the data used to generate quotes 102 is always up-to-date.

Moreover, retrieving of the quote data 116 is conducted via one or more APIs 122. In at least one embodiment, the one or more APIs 122 are connected to the CRM platform 116 is a cloud-based platform configured to manage the flow of quote data 116. When the quote request 108 is made, the one or more APIs 122 retrieve relevant data such as customer information, pricing models, and historical transaction records. The cloud-based platform provides the infrastructure for managing the quote data 116. The cloud-based platforms provide real time data access, and the ability to manage information efficiently. The cloud-based platform can dynamically handle requests to retrieve quote data 116, ensuring the process can be performed from anywhere, at any time, with minimal latency.

The cloud-based platform coordinates the flow of information between the CRM platform 120 and data sources 118. The data source 118 may include product databases, customer profiles, pricing catalogs, or custom data structures. The cloud-based platform ensures that data retrieved via one or more APIs 122 is accurate and relevant to the specific quote request 108, validating that all required information is gathered before presenting the quote 102 to the user 114. Furthermore, the cloud-based platform manages data security and compliance, ensuring that sensitive information such as customer details or pricing agreements is handled securely. The cloud environment allows for the implementation of encryption protocols, user access controls, and monitoring systems to detect any unauthorized data access, thereby maintaining the integrity of the process.

The data structure entry point 112 is configured to handle alternative deal structures, providing the necessary quote data 116 for validation through predefined data formats. Typically, the alternative deal structures may involve custom terms, tiered pricing, bundled services, or unique contractual conditions that do not fit into standard templates. The alternative deal structures are common, where each customer may require a tailored package that includes variations in pricing, service levels, delivery timelines, or volume discounts. For example, a software provider may offer a multi-year licensing agreement that includes a discount for increased user volume, maintenance services, and staggered payment options. The data structure entry point 112 is configured to manage these variations.

The data structure entry point 112 is designed to accommodate the deal structures by offering flexibility in how the quote data 116 is formatted and submitted for validation. By utilizing predefined data formats, the data structure entry point 112 ensures that complex quotes remain structured and follows a set standard, making it easier to validate. The data structure entry point 112 ensures that all elements of the deal, including pricing tiers, service levels, and delivery timelines, are captured in a clear, organized way. The predefined data format allows to recognize each element of the quote 102 and apply the correct validation checks

In operation 206, generating a prompt by a prompt generator 124 to guide the AI engine 106 to validate the retrieved quote data 116. The prompt is a structured set of instructions or queries presented to the AI engine 106. The AI engine 106 interprets the prompt to perform a task. The prompt is generated automatically by the prompt generator 124 to guide the AI engine 106 to begin the validation process. The generation of the prompt is based on specific criteria related to the quote request 108, such as pricing rules, customer-specific discounts, contractual terms. The prompt may include detailed conditions, such as verifying that pricing complies with company policies or ensuring that product configurations match user 114 requirements. The prompt is configured to provide precise instructions to the AI engine 106 to understand what aspects of the quote data 116 it is expected to validate.

The AI engine 106 is responsible for performing data processing, validation, and decision-making tasks. The AI engine 106 utilizes machine learning algorithms for interpreting the prompt and making decisions. The AI engine 106 uses the prompt to ensure that the quote data retrieved from the data sources 118 is accurate and consistent. The prompt allows the AI engine 106 to focus on specific areas of the quote data 116 that require validation. Typically, the validation is the process of verifying that the quote data 116 associated with the quote request 108 retrieved from the data sources 118 is correct, accurate, and compliant such as pricing, product details, and terms of service are accurate and aligned. The retrieved quote data 116 is the information pulled from data sources 118 like the CRM platform 120. The quote data 116 includes details about the customer, the products or services being quoted, the applicable pricing models, and any special terms or discounts that apply to the particular deal. Once the quote data 116 is retrieved, the quote data 116 is validated to ensure that there are no discrepancies or errors.

In operation 208, transferring the prompt to the AI engine 106 to validate the retrieved quote data 116. The validation comprises analyzing the quote data 116 against predefined rules and conditions, including price structures, terms, and conditions. The transfer of the prompt to the AI engine 106, triggers the AI engine 106 to validate the retrieved quote data 116. The prompt is structured to provide clear instructions to the AI engine 106, specifying rules and conditions to check and how to analyze the quote data 116 of the associated quote request 108. The AI engine 106 is designed to handle vast amounts of data in real-time, processing multiple quote requests 108 simultaneously. The AI engine 106 utilizes machine learning algorithms to understand what to validate and how to validate. The prompt guides the AI engine 106 to ensure that the quotes 102 having complex data sets, ranging from simple price checks to more detailed analyses of terms and conditions are validated precisely. The validation ensures reviewing the retrieved quote 102 provided by the user 114 adheres to predefined business rules and conditions.

The AI engine 106 is programmed to understand the nuances of each component of the quote 102, ensuring that the price structures, terms, and conditions are consistent. The AI engine 106 uses machine learning algorithms to dynamically adjust the validation criteria based on historical data and patterns identified in the previous quote requests 108. The AI engine 106 analyzes historical data from past quote requests 108 and discerns patterns, trends, and relationships. As the AI engine 106 processes more quote requests 108, the AI engine 106 identifies recurring patterns in pricing adjustments, discounts, or common errors. These insights enable the AI engine 106 to dynamically modify its validation criteria, enhancing accuracy and ensuring that the quotes 102 it evaluates are aligned. As the AI engine 106 processes quote requests 108, the AI engine 106 refines its understanding of how the set of predefined rules apply in various contexts.

The AI engine 106 can adapt to changes in real-time, ensuring that the validation process remains accurate and up-to-date. For instance, if the AI engine 106 detects that a specific product's pricing fluctuates seasonally based on historical data, the AI engine 106 can adjust its validation criteria to account for these variations during certain times of the year. Similarly, the AI engine 106 identifies that certain types of quote requests 108 often lead to errors. Moreover, the AI engine 106 learned from historical data allows it to recognize anomalies or outliers in new quote requests 108. If the new quote request 108 significantly deviates from established patterns, such as the quote 102 with an unusually high discount or a price that is much lower than expected the AI engine 106 can flag it for further review.

Once the AI engine 106 receives the prompt, the AI engine 106 is configured to validate the retrieved quote data 116. The validation customer information, product or service details, pricing, and any applicable terms and conditions. The validation ensures that the information within the quote 102 is accurate, consistent, and compliant. The validation is important where quotes 102 may involve complex pricing models, custom configurations, or contractual obligations. The AI engine 106 analyzes Price structures, terms and conditions, contractual obligations, multiple facets of the data, and predefined rules and conditions to ensure consistency.

The AI engine 106 analyzes the retrieved quote data 116 to ensure that the pricing applied to the quote 102 aligns with these predefined price structures. If the AI engine 106 detects that the price is either too high or too low compared to the agreed-upon pricing model, it will flag the discrepancy. This ensures that the customers are always quoted at the correct price, and the company avoids undercharging or overcharging. The AI engine 106, guided by the prompt, checks the terms and conditions within the retrieved quote data 116 to ensure that the quote data 116 match the company's standard policies or any customer-specific agreements that may have been made. The AI engine 106 is equipped to handle the level of complexity, cross-referencing the retrieved quote data 116 against the predefined contractual obligations stored. By validating the obligations, the AI engine 106 ensures that the quote accurately reflects the promises made to the customer. The predefined rules include ensuring that any discounts applied to the quote 102 do not exceed the maximum allowable discount percentage, verifying that the payment terms in the quote 102 align with standard terms, the products or services being quoted are available in the required quantities and can be delivered within the specified timeframe.

The step of automatically triggering the validation process upon submission of the quote request 108 and the process initiates without requiring manual intervention. Once the quote request 108 is submitted, the AI engine 106 automatically initiates the validation process without any need for human involvement. The automatically triggering of the validation process saves time, as it eliminates the waiting period between submission and review and allows handling a higher volume of quotes 102 with greater efficiency. The automatically triggering of the validation process eliminates human involvement in. By removing manual intervention, the quote generation system 100 accelerates the process and also reduces the errors associated with human oversight, such as overlooking key validation criteria or inputting incorrect data.

The AI engine 106 relies on rules and conditions used to carry out the validation process. The predefined rules and conditions include verification of terms and conditions, pricing accuracy, compliance with company policies, and alignment with customer-specific agreements. The AI engine 106 configured to verify terms and conditions is to check that the details align with the company's standard policies or any special agreements that may have been negotiated with the customer. For instance, some customers might have specific payment terms based on their history or relationship with the company. The AI engine 106 uses predefined rules to ensure that the correct terms are applied to each quote 102.

The quotes 102 involve detailed pricing structures that can include base prices, discounts, taxes, shipping fees, and other costs. Ensuring that the prices are calculated correctly is essential to avoid overcharging or undercharging. The AI engine 106 verifies that all pricing elements within the quote 102 adhere to the company's pricing policies. For example, the AI engine 106 checks whether any applied discounts fall within allowable limits or if there are any promotions or customer-specific pricing agreements that need to be reflected. The AI engine 106 ensures that all price calculations, from individual item costs to the overall total, are correct. The validation process also includes compliance with company policies. Every organization has its own set of internal policies that govern sales processes, including guidelines on pricing, discounts, payment terms, and product availability. These policies ensure that the company's operations remain profitable, legally compliant, and consistent across all transactions. During the validation process, the AI engine 106 checks whether the quote 102 complies with these internal policies.

The validation process includes ensuring that the quote 102 is aligned with customer-specific agreements. Many businesses have long-term relationships and often negotiate specific terms that differ from the company's standard offerings. These could include custom pricing, unique payment schedules, extended warranties, or other special conditions that have been agreed upon in previous contracts. The AI engine 106 is able to recognize these customer-specific agreements and apply them accurately to the quote 102. For example, if the customer has negotiated a 10% discount on all future purchases or extended payment terms beyond the standard 30 days, the AI engine 106 ensures that these conditions are reflected in the current quote 102.

In operation 210, generating a quality control result based on the validation. The quality control result indicates whether the quote 102 passes or fails the validation. The quality control (QC) is a systematic process used to ensure that quote 102 meets the necessary accuracy, compliance, and alignment with company policies, customer agreements, and market conditions before it is approved and forwarded. The quality control guarantees that no quote 102 with errors, inconsistencies, or policy violations progresses through the sales pipeline. The AI engine 106 evaluates the quote 102 based on predefined rules and conditions, after which it generates the quality control result by utilizing a quality control (QC) module 126 that provides immediate feedback on whether the quote 102 passes or fails the validation. The quote 102 undergoes a comprehensive validation process based on a set of predefined rules and conditions designed to verify critical aspects of the quote 102.

This validation process leverages the AI engine 106 which utilizes machine learning algorithms to ensure that each quote 102 is scrutinized against a detailed set of criteria. Once the AI engine 106 completes the validation, it generates a quality control result that reflects the outcome of the review. After the validation process is complete, the AI engine 106 generates the quality control result that indicates whether the quote 102 passes or fails validation by utilizing QC module 126. This result is a binary outcome, typically categorized as either “Pass” or “Fail.” If the quote 102 meets all the necessary validation criteria, the QC module 126 indicates that the quote 102 has passed the validation. This means that the quote 102 is accurate, compliant with company policies, properly aligned with user 114 specific agreements, and free from errors. Typically, the passing result signifies that the quote 102 can proceed to the next stage, whether that be approval, sending it to the customer via the user 114.

If the quote 102 fails to meet one or more of the predefined criteria, the QC module 126 indicates that it has failed validation. A failed result typically occurs due to errors in the quote 102, such as incorrect pricing, missing information, a violation of company policy, or a misalignment with user 102 specific agreements. When the quote 102 fails validation, the AI engine 106 usually provides detailed feedback outlining the specific issues that caused the failure.

Moreover, upon a successful validation and passing of the quote 102 from the QC module 126, the messaging systems or email automatically forwards the quote 102 for further processing, including submission for electronic signature through a document-signing platform 128. Once the quote has passed validation, the messaging systems or email takes over to forward the quote 102. The messaging system or email functionality can be customized to route the quote 102 to specific user 114. For example, once validated, the quote 102 might be forwarded to a sales manager for final review or approval, to the legal department for compliance checks, or directly to the customer for review and signature.

After the quote 102 passes the necessary validation checks and is forwarded for electronic signatures via document-signing platforms. The document-signing platforms, such as Adobe Sign, provide a legally binding method for signing documents electronically. The document-signing platform 128 is integrated with the automated quote system 100, allowing the quote 102 to be forwarded for signature seamlessly. Once the quote 102 is forwarded to the document-signing platform 128, via messaging systems or email that the quote 102 is ready for review and signature.

Below is an exemplary specially engineered prompt that is populated by the prompt generator 124 with exemplary data, such as a quote, address data, subsidiary data, and mapping table information, so that the prompt guides and constrains the AI engine 106 for the review of the exemplary quote:

You are an expert quality control agent.
Your task is to review the following quote values and provide
feedback:
- The Quote subsidiary is: Jive Software, LLC
- The Quote customForm is: ESW Quote ONPREM - Full T&Cs
- The quote is a maintenance quote.
- The quote is a renewal quote.
- Shipping Address listed in the quote: Cresset Capital
Management, LLC
444 West Lake Street
Suite 4700
Chicago IL 60606
United States
- Billing Address listed in the quote: Mimi Wing
Cresset Capital Management, LLC
444 West Lake Street
Suite 4700
Chicago IL 60606
United States
The subsidiary lookup:
###
{ “Business Unit”: “IgniteTech”, “GM”: “Eric Vaughan”, “NetSuite
Class”: “Jive Product”, “Product Set”: “Jive”, “Contracting
Entity for US / Domestic Customers / Mainland UAE Customers”:
“Jive Software, LLC”, “Contracting Entities for German/Austrian
Customers”: “Jive Software, LLC”, “Contracting Entities for
Japan Customers”: “Jive Software, LLC”, “Contracting Entity for
Other Customers”: “Jive Software, LLC”, “Comments”: “”, “date
product acquired by group”: “” }
###
The items in the quote:
###
[“Jiv-OP-Jiv-SIL”,“Jiv-OP-Jiv-STA”]
###
The names of the items usually contain the prefix like -SAAS- or
-PS- that is used to determine the customForm.
The customForm mapping table:
###
{ “SAAS”: “ESW Quote SAAS - Full T&Cs”, “On-Premises or OP”:
“ESW Quote ONPREM - Full T&Cs”, “Professional services or PS”:
“ESW Quote PS - Full T&Cs”, “Maintenance / Support renewal only
or hardware”: “ESW Quote MAINT - Full T&Cs”, “Existing Reseller
Cases. (Including New end user cases)”: “ENG: NEW RESELLER'S
QUOTE”, “Reseller Cases where the reseller agreement is not
available.”: “Select the appropriate form from SAAS, ON PREM or
MAINT or RENWAL (If previously full T&Cs are Signed)”,
“Renewal”: “ESW Quote Renewal - No T&Cs attachments”}
###
Additional notes:
1. If the Shipping address differs from the billing address,
this means that this is a reseller quote.
2. If there is only one item ending SIL, GOL or PLA, then the
quote should use the “ESW Quote MAINT - Full T&Cs” customForm
(unless it is a reseller quote); this guidance takes precedence
over the customForm mapping table.
Rules for generating feedback:
1. Determine if the subsdiary refName in the quote the exact
same one as in the provided lookup data.
Respond exclusively with the JSON data string. Ensure that the
response contains only the JSON structure without any markdown
or other text formatting elements. Use the following JSON
structure and do not include code block annotations or any
formatting outside of the JSON syntax:
{
“subsidiary_check”: {
“Reasoning_for_decision”: “Reasoning”,
“Pass”: true/false
}
}

Prompt explanation: The above prompt guides AI engine 106 to reviewing the quote 102 for a maintenance renewal from Jive Software, LLC. The details include matching the quote's subsidiary with a lookup table, ensuring consistency in the custom form based on item names and addresses, and following specific mapping rules. The quote 102 involves Cresset Capital Management, LLC, and both shipping and billing addresses are the same, indicating it is not a reseller quote. The selected custom form should reflect an on-premises maintenance renewal. The feedback response should be structured in a JSON format with checks on the subsidiary and other relevant information.

In operation 212, providing real-time feedback to the user 114. The feedback includes detailed information on any discrepancies or required corrections if the quality control result indicates a failure. Typically, providing feedback means that the user 114 has not to wait for long periods to find out if the quote 102 is valid or needs adjustments. The real-time nature of the feedback also enhances decision-making. If the quote 102 fails the quality control checks, the user 114 is notified immediately, and they can make informed decisions on how to proceed. This rapid feedback loop, ensuring that any discrepancies or errors are addressed promptly and that valid quotes 102 can be forwarded for approval without unnecessary delays.

When the QC module 126 indicates the failure, the AI engine 106 provides detailed information about the discrepancies that caused the failure. The discrepancies include incorrect pricing, non-compliance with terms and conditions, missing or incorrect information, violations of company policies. The feedback may specify that certain price points are either too high or too low, or that the pricing doesn't align with predefined discount limits or market standards. The AI engine 106 highlights where the terms and conditions included in the quote 102 don't comply with company policies or customer-specific agreements. If certain required fields are incomplete or contain inaccurate data, the feedback will pinpoint these areas. The AI engine 106 will flag the quote 102 that breach internal policies, such as exceeding discount thresholds or offering services that aren't currently available. This level of detail is critical for enabling the user 114 to correct errors efficiently.

Below is QC module 126 response:

```
{
  “subsidiary_check”: {
  “Reasoning_for_decision”: “The subsidiary refName
‘Jive Software, LLC’ in the quote matches exactly with the
‘Contracting Entity for US / Domestic Customers / Mainland UAE
Customers' in the provided subsidiary lookup data.”,
  “Pass”: true
  },
  “dates_check”: {
  “Reasoning_for_decision”: “Start date is before
End date, Expiry date is after the current date.”,
  “Pass”: true
  }
}
```

The above response checks the information about subsidiary and date. The subsidiary check confirms that the subsidiary “Jive Software, LLC” in the quote 102 matches exactly with the contracting entity for US/Domestic Customers/Mainland UAE Customers in the provided subsidiary lookup data. It passed the check. The dates check verifies that the start date is before the end date, and the expiry date is after the current date. This check is also passed.

In at least one embodiment, the AI engine 106 also provides actionable guidance on how to correct the errors so that the quote 102 can pass validation in the next submission. This feedback is often prescriptive, offering specific steps the user 114 should follow to fix the issues identified during the validation process. This corrective feedback is essential because it simplifies the process for the user 114. Instead of spending time trying to interpret what went wrong or how to fix it, the user 114 is given clear instructions on what changes need to be made. This improves the overall efficiency of the quote generation system 100. Additionally, the AI engine 106 may use historical data or machine learning algorithms to offer optimized suggestions. For example, if certain pricing models or discount structures have worked for similar quotes 102 in the past, the AI engine 106 might recommend those to the user 114.

The feedback provided to the user 114 includes detailed instructions for correcting identified discrepancies, and the feedback is delivered through automated messaging systems or email in real time. When the AI engine 106 identifies discrepancies during the validation of the quote 102, the discrepancy in the form of feedback is provided to the user 114. The AI engine 106 outlines what the discrepancies are and what actions need to be taken to resolve them. For example, if the price structure in the quote 102 doesn't align with company policy, the feedback would indicate exactly which item or section contains the incorrect pricing and would suggest the appropriate value based on predefined rules. The feedback helps the user 114 to immediately understand where the problem lies, without needing to investigate further or waste time deciphering complex errors. The feedback is delivered in real time through automated messaging systems or email.

The real-time delivery ensures that the users 114 are immediately informed of any issues and can take corrective action without delay. The automated messaging systems or email instantly notify the user 114 the moment the quote 102 fails validation. The delivery of feedback via automated messaging systems or email eliminates the need for manual intervention from managers to communicate issues or discrepancies to user 114. The feedback is generated and delivered instantly, removing bottlenecks and allowing for faster corrections and re-submissions.

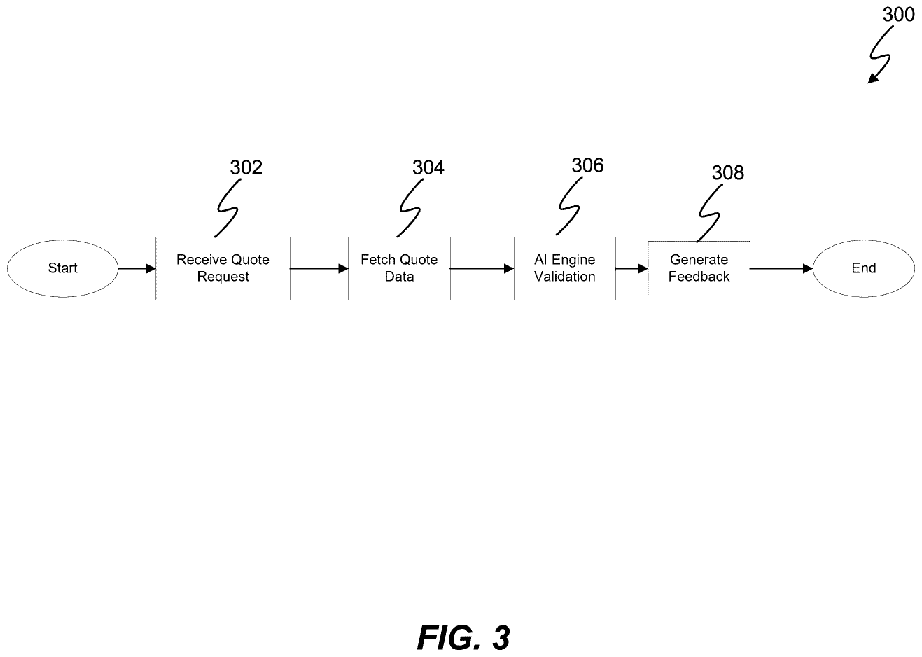

FIG. 3 is a feedback generation process 300, which is an embodiment of the quote generation process 200 of FIG. 2. At step 302, receive the quote request 108. The quote request 108 is provided by the user 114 for the generation of the quote 102. The user 114 utilizes the CRM system 110 to generate the quote request 108. The quote request 108 includes at least one of renewal, professional services, or new business quote. At step 304, the fetch quote data 116 by the AI engine 106, associated with the quote request 108 from the data sources 118. The data source 118 includes CRM platform 120 which is connected to the AI engine 106 via one or more APIs 122. At step 308, validate the retrieved quote data 116 via AI engine 106. The AI engine 106 is guided by the prompt, generated by the prompt generator 124, to validate the quote data 116. The AI engine 106 utilizes machine learning algorithms to understand what to validate and how to validate. The AI engine 106 uses machine learning algorithms to dynamically adjust the validation criteria based on historical data and patterns identified in the previous quote requests 108. At step 308, the AI engine 106 is configured to generate feedback based on the validation process. The feedback includes detailed information on any discrepancies or required corrections if the QC module 126 indicates a failure. The AI engine 106 provides detailed information about the discrepancies that caused the failure. The feedback provided to the user 114 includes detailed instructions for correcting identified discrepancies, and the feedback is delivered through automated messaging systems or email in real-time.

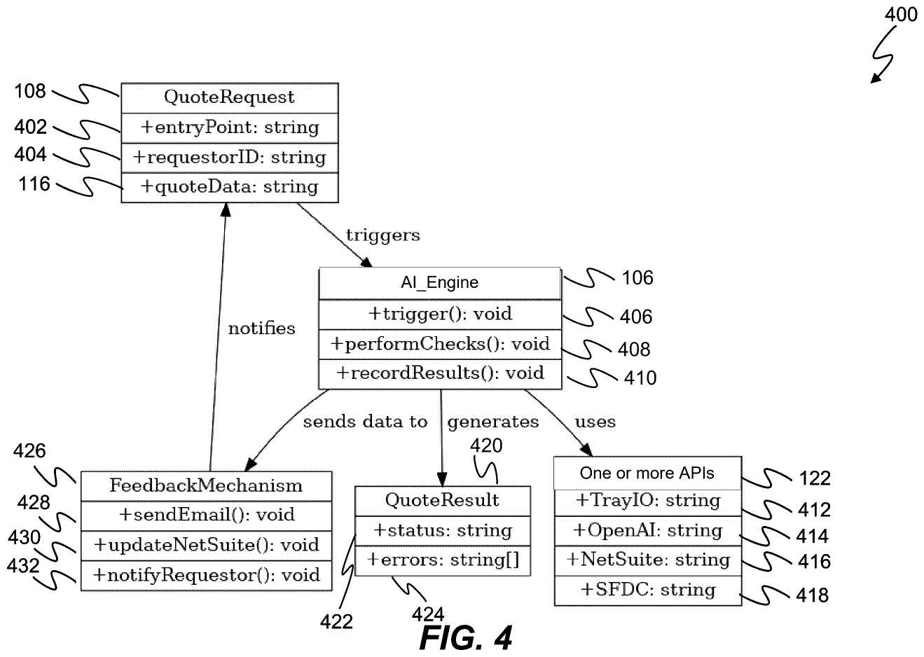

FIG. 4 depicts a data structure 400 for generating validated quotes. The quote request 108 comprises a plurality of components such as entry point 402, requestor ID 404 and quote data 116. The entry point 402 refers to the place where the execution of the quote request 108 begins. The entry point 402 can be the CRM system 110 or the data structure entry point 112. The requestor ID 404 refers to a unique user ID that has initiated the process of generating the quote request 108. The quote data 116 refers to the data associated with the requested quote request 108. The quote request 108 triggers the AI engine 106.

The AI engine 106 comprises a plurality of components such as trigger 406, perform checks 408 and record results 410. The trigger 406 refers to the initiation of the process, in response to the quote request 108. The trigger 406 involves setting off a sequence of events to achieve a desired outcome. The trigger 406 implies starting the process through the predefined set of criteria or conditions. The perform checks 408 involves carrying out the validation process to ensure that specific standards, requirements, or conditions are met. The record results 410 records the results obtained from the perform checks 408. The result includes the pass or fail of the quote request 108. The AI engine 106 uses one or more APIs 122 integrated with the AI engine 106.

The one or more APIs 122 comprises a plurality of components such as TrayIO 412, OpenAI 414, NetSuite 416, SFDC 418. The TrayIO 412 is the integration that allows user 114 to streamline their workflow. The TrayIO 412 enables the user 114 to easily build automated processes and transfer data. The OpenAI 414 is an artificial intelligence research laboratory which is integrated to allow the AI engine to perform the validation process. The NetSuite 416 is a cloud-based suite that includes modules for financial management, enterprise resource planning (ERP), customer relationship management (CRM), and e-commerce used to manage various operations, including financials, orders, inventory, shipping, and billing. The SFDC 418 is a cloud-based CRM platform 120 is used to manage data, track sales leads, and so forth. The AI engine 106 generates quotes result 420.

The quotes result 420 comprises a plurality of components such as status 422 and errors 424. The quotes result 420 refers to the result generated by the AI engine 106 based on the validation process. The status 422 is a way to indicate the progress of the quote request 108. The status 422 can either “Pass” or “Fail.” If the quote request 108 meets all the necessary validation criteria, the quality control result indicates that quote request 108 has passed the validation. The error 424 refers to the specific errors associated with the quote request 108. The AI engine 106 sends the data to a feedback mechanism 426.

The feedback mechanism 426 is the mechanism established to provide the feedback on the requested quote request 108. The feedback mechanism 426 comprises a plurality of components such as send email 428, update NetSuite 430 and notify requestor 432. The send email 428 to the requestor such as user 114 based on the status 422 of the quote request 108. The update NetSuite 430 refers to updating the NetSuite based on the feedback on the requested quote request 108. The notify requestor 432 refers to notifying the requestor such as user 114 the status of the requested quote request 108.

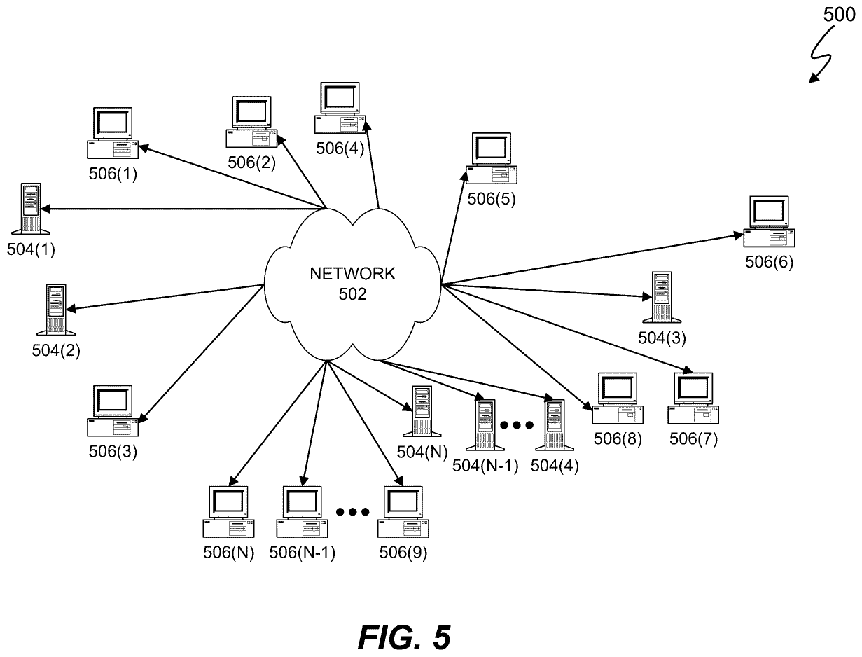

FIG. 5 is a block diagram illustrating a network environment in which a quote generation system 100 and quote generation system 100 may be practiced. Network 502 (e.g. a private wide area network (WAN) or the Internet) includes a number of networked server computer systems 504(1)-(N) that are accessible by client computer systems 506(1)-(N), where N is the number of server computer systems connected to the network. Communication between client computer systems 506(1)-(N) and server computer systems 504(1)-(N) typically occurs over a network, such as a public switched telephone network over asynchronous digital subscriber line (ADSL) telephone lines or high-bandwidth trunks, for example communications channels providing T1 or OC3 service. Client computer systems 506(1)-(N) typically access server computer systems 504(1)-(N) through a service provider, such as an internet service provider (“ISP”) by executing application specific software, commonly referred to as a browser, on one of client computer systems 506(1)-(N).

Client computer systems 506(1)-(N) and/or server computer systems 504(1)-(N) are specialized computer programmed to improve conventional computer systems to implement and utilize the quote generation system 100 and quote generation system 100. The type of computer system that can be specially programmed to implement and utilize the quote generation system 100 and quote generation system 100 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the quote generation system 100 and quote generation system 100 can be implemented using code stored in a tangible, non-transient computer readable medium and executed by one or more processors. In at least one embodiment, the quote generation system 100 and quote generation system 100 can be implemented completely in hardware using, for example, logic circuits and other circuits including field programmable gate arrays.

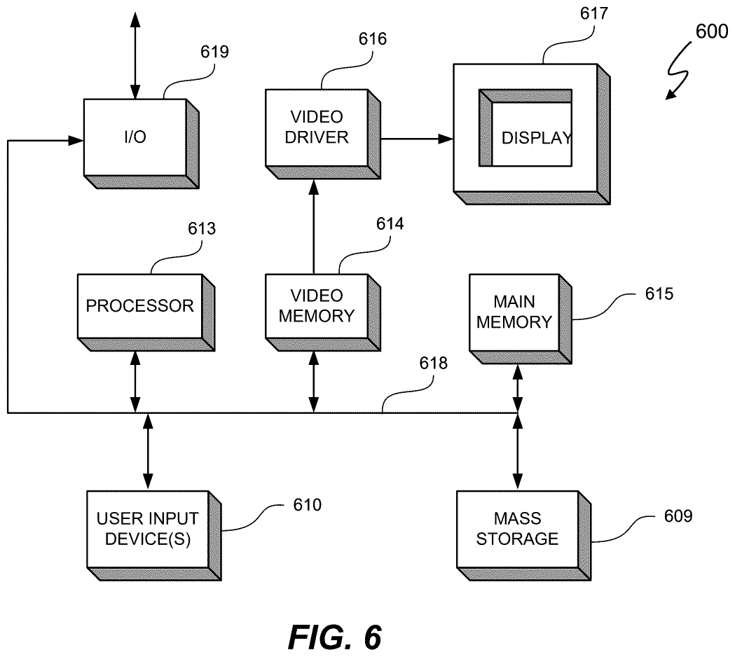

Embodiments of the quote generation system 100 and quote generation system 100 can be implemented on a computer system such as a special-purpose, special-programmed computer 600 illustrated in FIG. 6. Input user device(s) 610, such as a keyboard and/or mouse, are coupled to a bi-directional system bus 618. The input user device(s) 610 are for introducing user input to the computer system and communicating that user input to processor 613. The computer system of FIG. 6 generally also includes a non-transitory video memory 614, non-transitory main memory 615, and non-transitory mass storage 609, all coupled to bi-directional system bus 618 along with input user device(s) 610 and processor 613. The mass storage 609 may include both fixed and removable media, such as a hard drive, one or more CDs or DVDs, solid state memory including flash memory, and other available mass storage technology. Bus 618 may contain, for example, 32 of 64 address lines for addressing video memory 614 or main memory 615. The system bus 618 also includes, for example, an n-bit data bus for transferring DATA between and among the components, such as CPU 609, main memory 615, video memory 614 and mass storage 609, where “n” is, for example, 32 or 64. Alternatively, multiplex data/address lines may be used instead of separate data and address lines.

I/O device(s) 619 may provide connections to peripheral devices, such as a printer, and may also provide a direct connection to a remote server computer systems via a telephone link or to the Internet via an ISP. I/O device(s) 619 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 609, into main memory 615 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the display 617. Video amplifier 616 is well known in the art and may be implemented by any suitable means. This circuitry converts pixel DATA stored in video memory 614 to a raster signal suitable for use by display 617. Display 617 is a type of monitor suitable for displaying graphic images.

The computer system described above is for purposes of example only. The quote generation system 100 and quote generation system 100 may be implemented in any type of computer system or programming or processing environment. It is contemplated that the quote generation system 100 and quote generation system 100 might be run on a stand-alone computer system, such as the one described above. The quote generation system 100 and quote generation system 100 might also be run from a server computer systems system that can be accessed by a plurality of client computer systems interconnected over an intranet network. Finally, the quote generation system 100 and quote generation system 100 may be run from a server computer system that is accessible to clients over the Internet.

Although embodiments have been described in detail, it should be understood that various changes, substitutions, and alterations can be made hereto without departing from the spirit and scope of the invention as defined by the appended claims

What is claimed is:

1. A method for guiding an Artificial Intelligence (AI) engine for automating quality control of quotes in quote generation comprising:
executing code using one or more processors of a computer system to cause the computer system to perform operations comprising:
receiving a quote request from a customer relationship management (CRM) system or a data structure entry point, wherein the quote request includes at least one of renewal, professional services, or new business quotes;
retrieving a quote data associated with the quote request from a data sources, including a CRM platform, via one or more application programming interfaces (APIs), wherein the retrieval is triggered by the submission of the quote request;
generating a prompt by a prompt generator to guide the AI engine to validate the retrieved quote data;
transferring the prompt to the AI engine to validate the retrieved quote data, wherein the validation comprises analyzing the quote data against predefined rules and conditions, including price structures, terms, and conditions;
generating a quality control result based on the validation, wherein the quality control result indicates whether the quote passes or fails the validation; and
providing real-time feedback to a user, wherein the feedback includes detailed information on any discrepancies or required corrections if the quality control result indicates a failure.

2. The method of claim 1 wherein the data structure entry point is configured to handle alternative deal structures, providing the necessary quote data for validation through predefined data formats.

3. The method of claim 1 wherein retrieving the of quote data is conducted via one or more APIs, wherein the one or more APIs are connected to a cloud-based platforms configured to manage the flow of data between the AI engine and the data sources.

4. The method of claim 1 wherein the AI engine uses machine learning algorithms to dynamically adjust the validation criteria based on historical data and patterns identified in the previous quote requests.

5. The method of claim 1 further comprising the step of automatically triggering the validation process upon submission of the quote request, wherein the process initiates without requiring manual intervention.

6. The method of claim 1 wherein the predefined rules and conditions used for validation include verification of terms and conditions, pricing accuracy, compliance with company policies, and alignment with customer-specific agreements.

7. The method of claim 1 wherein the feedback provided to the user includes detailed instructions for correcting identified discrepancies, and the feedback is delivered through automated messaging systems or email in real time.

8. The method of claim 1 wherein upon a successful validation and passing of the quality control checks, the messaging systems or email automatically forwards the quote for further processing, including submission for electronic signature through a document-signing platform.

9. A system for guiding an Artificial Intelligence (AI) engine for automating quality control of quotes in quote generation comprising:
one or more processors of a computer system; and
a memory, coupled to the one or more processors, that stores code and execution of the code by the one or more processors causes the computer system to perform operations comprising:
receiving a quote request from a customer relationship management (CRM) system or a data structure entry point, wherein the quote request includes at least one of renewal, professional services, or new business quotes;
retrieving a quote data associated with the quote request from a data sources, including a CRM platform, via one or more application programming interfaces (APIs), wherein the retrieval is triggered by the submission of the quote request;
generating a prompt by a prompt generator to guide the AI engine to validate the retrieved quote data;
transferring the prompt to the AI engine to validate the retrieved quote data, wherein the validation comprises analyzing the quote data against predefined rules and conditions, including price structures, terms, and conditions;
generating a quality control result based on the validation, wherein the quality control result indicates whether the quote passes or fails the validation; and
providing real-time feedback to a user, wherein the feedback includes detailed information on any discrepancies or required corrections if the quality control result indicates a failure.

10. The system of claim 9 wherein the data structure entry point is configured to handle alternative deal structures, providing the necessary quote data for validation through predefined data formats.

11. The system of claim 9 wherein retrieving the of quote data is conducted via one or more APIs, wherein the one or more APIs are connected to a cloud-based platforms configured to manage the flow of data between the AI engine and the data sources.

12. The system of claim 9 wherein the AI engine uses machine learning algorithms to dynamically adjust the validation criteria based on historical data and patterns identified in the previous quote requests.

13. The system of claim 9 further comprising the step of automatically triggering the validation process upon submission of the quote request, wherein the process initiates without requiring manual intervention.

14. The system of claim 9 wherein the predefined rules and conditions used for validation include verification of terms and conditions, pricing accuracy, compliance with company policies, and alignment with customer-specific agreements.

15. The system of claim 9 wherein the feedback provided to the user includes detailed instructions for correcting identified discrepancies, and the feedback is delivered through automated messaging systems or email in real time.

16. The system of claim 9 wherein upon a successful validation and passing of the quality control checks, the messaging systems or email automatically forwards the quote for further processing, including submission for electronic signature through a document-signing platform.
